(19) United States
(12) Patent Application Publication
(10) Pub. No.: US 2014/0165864 A1
(43) Pub. Date: Jun. 19, 2014

(54) SYSTEM AND METHOD OF GENERATING PRINTED MEDIA

(71) Applicant: MELISSA OPPENHEIM, WESTON, FL (US)

(72) Inventor: MELISSA OPPENHEIM, WESTON, FL (US)

(21) Appl. No.: 14/105,948

(22) Filed: Dec. 13, 2013

Related U.S. Application Data
(60) Provisional application No. 61/736,898, filed on Dec. 13, 2012.

(51) Int. Cl. B41F 15/08

(52) U.S. Cl. CPC B41F 15/08
USPC 101/129

(57) ABSTRACT

A system and method of generating a combined media print receives image data representing an original image at a computer system having at least a non-transitory storage medium and a hardware processor communicatively connected thereto. A quantization algorithm is executed by the hardware processor of the computer system to produce quantized image data from the received image data. Using the quantized image data, the system creates a printing screen having printed thereon a rendering of the quantized image data. The printing screen is aligned on top of a physical substrate having the original image printed or rendered thereon. One or more inks are then applied to the printing screen and, are overlaid onto portions of the original image printed or rendered onto the physical substrate.

### CROSS-REFERENCE TO RELATED APPLICATIONS

This application claims priority to U.S. Prov. Pat. App. No. 61/736,898, filed Dec. 13, 2012, which is hereby incorporated by reference in its entirety as if set forth herein.

### BACKGROUND OF THE INVENTION

1. Field of the Invention

The invention relates to the field of image printing, and in particular to systems and methods of generating printed media using a computer.

2. Description of the Related Art

Screen printing is a printing technique that uses a prepared mesh screen to transfer ink or other pigments to a substrate such as paper or cloth. Screen printing provides a number of advantages over traditional digital printing, such as flexibility to use multiple colors, improved textural qualities based on the ink composition, repeatability for multiple prints with different inks, and the like. However, screen printing is also limited with respect to digital printing, for example, in producing highly detailed images and color gradients.

Certain systems are known that utilize an electronic color image with a silk-screen process. For example, U.S. Pat. No. 6,732,641 to Fissell discloses a method for providing display images in an illuminated display device, wherein an electronic color image is converted into a CMYK file, from which a film positive of each of the C channel, the M channel, the Y channel and an inverted halftone black and white channel is created. In Fissell, a silk screen is produced from each of the film positives which can be used to silk screen onto an image-bearing medium. See, for example, col. 9 of Fissell, line 7-col. 10, line 61. Fissell discloses that the image-bearing medium is made from any suitable generally clear material, such as glass, acrylic or other plastic. See, for example, col. 4 of Fissell, lines 57-59. Similarly, U.S. Pat. No. 5,927,191 to Wheatley, Jr., et al., discloses a method and apparatus for screen printing a converted digitalized image onto a hard surface, such as glass or a mirror.

U.S. Pat. No. 5,730,052 to Mather discloses a method for applying and reproducing an original visual image such as a computer generated image, an oil painting or photograph, onto various surfaces using silk screen ink techniques for a high resolution permanent image transformation, especially useful on objects having a course or toughened surface, such as a football, basketball, or the like. See, for example, the Abstract of Mather.

U.S. Pat. No. 5,174,204 to Meier et al., discloses a method of producing decorative designs and articles having a three dimensional appearance by deleting portions of the image and printing the design so that the background color of the substrate upon which the design is printed will be allowed to show through in a large portion of the final decorative object. See, for example, col. 1 of Meier et al., lines 32-67. Meier et al., discloses that a large portion of the area of the object, in the range of about 20-80% of the area of the substrate, will be left blank in the illustration so that after printing, the substrate will be seen in the final object and the smaller details of the design object are deleted in the illustration. See, for example, col. 2 of Meier et al., lines 1-9.

The foregoing references utilize computerized image data to generate silk screens, but do not disclose utilizing the silk screens so generated to silk screen over portions of the original image printed on a substrate.

U.S. Pat. No. 6,038,977 to Haney et al., discloses a multiple printing process registration method in which a substrate having a first image printed thereon is mounted on a digital printer to be used to print a second image in a desired alignment with the first image. See, for example, the Abstract of Haney et al. Haney et al., discloses that the first image can be printed onto a flexible substrate using a silk screening process and the second image is printed on the substrate with a digital printer. See, for example, col. 3 of Haney et al., lines 20-42.

What is needed is a system and method wherein a combined media article is generated by silk screening over an original printed image using silk screens generated from image data quantized from data representative of the original image.

### SUMMARY OF THE INVENTION

The present invention overcomes the disadvantages of the prior art. In one particular embodiment of the invention, a system and method are provided for generating printed media wherein an original printed image is overlaid (superimposed) with at least one image silk screened thereon using a silk screen generated from quantized image data of the original image. Certain embodiments of the present invention utilize multiple printing techniques, such as a combination of digital printing and screen printing to produce beneficial visual effects that would be difficult or impossible to achieve otherwise.

In one particular embodiment of the invention, a method of generating a print of an image is provided in which a substrate having an original image printed thereon is silk screened using one or more silk screens created from quantized data of the original image. For example, in one particular embodiment of the method, image data representing an original image is received at a computer system including at least a non-transitory storage medium and a hardware processor communicatively connected thereto. The computer system processes the received image data, using a quantization algorithm, to produce quantized image data. As is understood in the art, such a quantization algorithm can be executed by a hardware processor of the computer system. At least one printing screen is generated from the quantized image data, and one or more inks are printed onto a physical substrate through the printing screen. In one particular embodiment of the invention, the physical substrate has printed thereon an original printed image corresponding to the originally received image data.

In one particular embodiment of the invention, the quantization algorithm is based at least in part on one or more parameters configured to adjust the produced quantized image data.

In another particular embodiment of the invention, the quantization algorithm includes at least a first conversion of the received image data to a grayscale image, and further includes a second conversion of the grayscale image to produce the quantized image data.

In a further particular embodiment of the invention, the second conversion is based at least in part on a brightness parameter and a blurring parameter.

In still a further particular embodiment of the invention, the method also includes displaying a preview of the quantized image to the user subsequent to applying the quantization algorithm.

In yet another particular embodiment of the invention, the method also includes receiving updated quantization parameters from the user, and reapplying the quantization algorithm based at least in part on the updated quantization parameters to update the quantized image data.

In one particular embodiment, the quantized image data represents an image having exactly two colors. If desired, in the present particular embodiment, the two colors consist of black and white.

In one particular embodiment of the invention, more than one printing screen is created from the quantized image data, each of which incorporates a portion of the quantized image data.

Optionally in any of the aforementioned embodiments, printing onto the physical substrate comprises registering the printing screen in alignment with the original image (i.e., the rendering of the image data) printed on the physical substrate.

In one particular embodiment of the invention, the physical substrate is a sheet of archival photo paper.

Optionally in any of the aforementioned embodiments, the printing screen can be created automatically under control of the computer system. Alternately, if desired, the printing screen can be created at least in part by a manual process separate from the computer system.

Optionally in any of the aforementioned embodiments, the one or more inks silk screened onto the physical substrate are printed automatically under control of the computer system. However, if desired, the one or more inks can be printed onto the physical substrate at least in part by a manual process separate from the computer system.

One particular embodiment of the invention includes a computer system including a computer processor and a storage medium communicatively connected to the computer processor. The storage medium has stored thereon a plurality of modules configured to be executed on the computer processor. The system includes an image receiving module configured to receive, from a user, image data at a computer system comprising at least a non-transitory storage medium and a hardware processor communicatively connected thereto. The system includes a quantization module configured to apply a quantization algorithm to the received image data to produce quantized image data. The quantization algorithm is executed on the hardware processor of the computer system. The quantized image data is used to create a printing screen representative of the quantized image data. The printing screen is configured to be used in printing one or more inks onto a physical substrate through the printing screen. The physical substrate has printed thereon a rendering of the received image data.

In another particular embodiment of the invention, a non-transitory, computer-readable medium is provided which has, stored thereon, a plurality of executable instructions configured to be executed on a computer system comprising a hardware processor. The instructions include an image receiving module configured to receive, from a user, image data at a computer system comprising at least a non-transitory storage medium and a hardware processor communicatively connected thereto. The instructions include a quantization module configured to apply a quantization algorithm to the received image data to produce quantized image data. The quantization algorithm is executed on the hardware processor of the computer system. The quantized image data is configured to be used to create a printing screen incorporating (i.e., representing) the quantized image data. The printing screen is configured to be used in printing one or more inks onto a physical substrate through the printing screen. The physical substrate has printed thereon a rendering of the received image data.

Other features, which are considered as characteristic for the invention, are set forth in the drawings and the appended claims.

Although the invention is illustrated and described herein as embodied in system and method of generating printed media, it is nevertheless not intended to be limited to the details shown, since various modifications and structural changes may be made therein without departing from the spirit of the invention and within the scope and range of equivalents of the claims.

The construction of the invention, together with additional objects and advantages thereof, will be best understood from the following description of the specific embodiment when read in connection with the accompanying drawings.

### BRIEF DESCRIPTION OF THE SEVERAL VIEWS OF THE DRAWING

The patent or application file contains at least one drawing executed in color. Copies of this patent or patent application publication with color drawing(s) will be provided by the Office upon request and payment of the necessary fee.

FIG. 1 is an exemplary block diagram of a combined media printing system in accordance with one particular embodiment of the present invention.

FIG. 2 is a flowchart of a process of generating a printed image in accordance with one particular embodiment of the present invention.

FIG. 3 is an exemplary original image useful in illustrating a method in accordance with the present invention.

FIG. 4 is an exemplary quantized image, based on the image of FIG. 3, generated according to one particular embodiment of a method of the present invention.

FIG. 5 is an exemplary representation of a printed article in accordance with one particular embodiment of the present invention, wherein the quantized image of FIG. 4 is screen printed on top of a printed copy of the original image of FIG. 3.

FIG. 6 is an exemplary block diagram of a computer system that is configured by software to perform the methods described herein, in accordance with one particular embodiment of the invention.

### DESCRIPTION OF THE PREFERRED EMBODIMENTS

For simplicity and illustrative purposes, the principles of the present teachings are described by referring mainly to exemplary embodiments thereof. However, one of ordinary skill in the art would readily recognize that the same principles are equally applicable to, and can be implemented in, all types of systems, and that any such variations may be included in various embodiments. Moreover, in the following detailed description, references are made to the accompanying figures, which illustrate specific embodiments. Electrical, mechanical, logical and structural changes can be made to various embodiments without departing from the spirit or scope of the present invention. It will be understood that the embodiments disclosed may be varied, augmented, or altered and that elements may be exchanged with their equivalents, and that elements may be implemented in different combinations and in different ways.

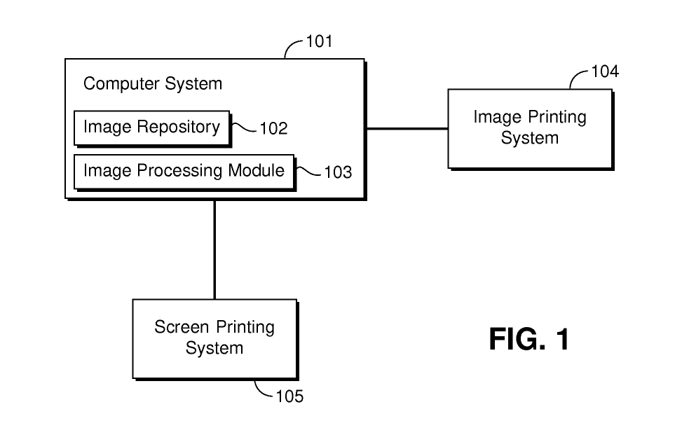

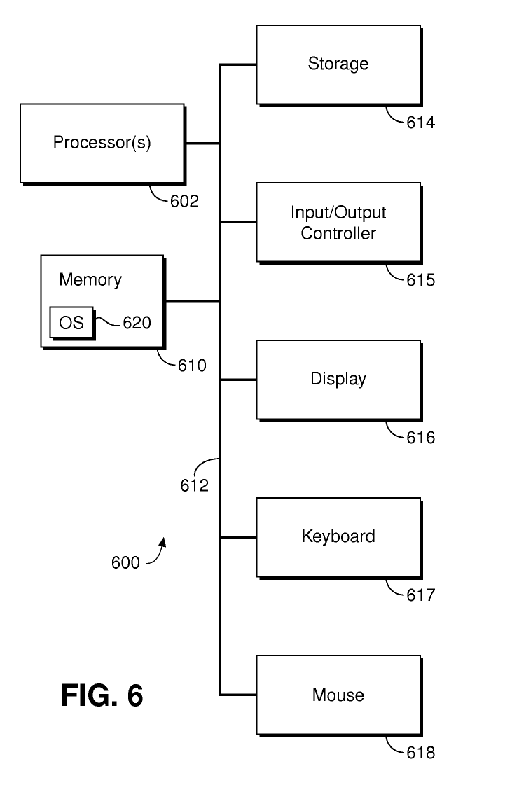

FIG. 1 is a block diagram of a combined media printing system configured to perform methods described herein, and can be used with any embodiment of the present invention, as desired. The combined media printing system may include further elements and/or any subset of the elements shown, and those elements may be arranged differently from the presented arrangement. The elements may be implemented as hardware components such as hardwired and/or integrated electronic circuitry, and/or as software modules stored on computer storage media such as volatile memory and/or nonvolatile storage. The combined media printing system illustrated in FIG. 1 may include one or more computer systems or devices 101, including, but not limited to, the computer system 600 of FIG. 6.

Referring now to FIGS. 1 and 6, in accordance with one particular embodiment of the invention, the computer system 101 is configured by, one or more modules implemented in hardware and/or software. For example, image repository 102 may include one or more non-transitory storage devices storing data representing one or more images. Image repository 102 may further include software code, indexing tables and/or pointers configured to access the image data stored in image repository 102. Image processing module 103 is configured to execute algorithms to transform image data, such as that stored in image repository 102, in accordance with the present invention. Such algorithms may include image resizing algorithms, image rasterizing algorithms, image quantization algorithms, and the like. In one particular embodiment, some or all of the algorithms of image processing module 103 may be included in a digital image manipulation program, such as ADOBE® PHOTOSHOP® software.

Computer system 101 may be connected to an image printing system 104, such as a digital printer. The connection may be through a direct connection (e.g., USB), via a network connection, or any other wired or wireless connection, as desired. Image printing system 104 may be an inkjet printer, a laser printer, an offset lithography printer, and/or other printing system. The computer system 101 may transmit images, possibly from image repository 102 and possibly modified using one or more of the algorithms of image processing module 103, to image printing system 104 to produce physical prints of the images. Alternately, images may be manually transferred to image printing system 104, for example by transportable storage media such as a USB thumb drive, in which case image printing system 104 need not be directly connected to computer system 101.

Computer system 101 may further be connected to screen printing system 105, by direct cable connection, network connection, and/or any other wired or wireless communication connection, in a similar manner as described with respect to image printing system 104. The process of screen printing generally involves producing a printing screen made of a mesh fabric, which has been treated to make certain portions of the screen impermeable to printing inks. The mesh count of the screen affects the degree of precision of prints made from that screen and the types of inks that may be used; in an embodiment screens with a mesh count of 200-300 are used. The treatment on the screens is generally a light-sensitive emulsion compound that hardens when exposed to light, so that selectively exposing the treated screen to light and then washing the unhardened compound off makes the screen impermeable to ink in the portions exposed to light, as explained in greater detail below. The screen is placed atop a printing substrate, such as paper or fabric, and ink is pushed over the screen. The ink permeates through the desired portions of the screen based on the screen treatment, and thus prints onto the paper. Although the following specification focuses on screen printing techniques, it will be understood that various embodiments can be adapted to other printing technologies without departing from the scope of the present invention.

Screen printing system 105 may be configured to automatically prepare printing screens, ink the screens, transfer ink from the screens onto printable substrates, and/or other screen printing processes, either under the control of the processor 103 of the computer system 101, or under the control of an appropriately configured processor in or local to the screen printing system 105. Screen printing system 105 may, in some embodiments, include some or all of image printing system 104. In an alternate embodiment, some or all of the screen printing processes may be manually performed, rather than being controlled by a computer system.

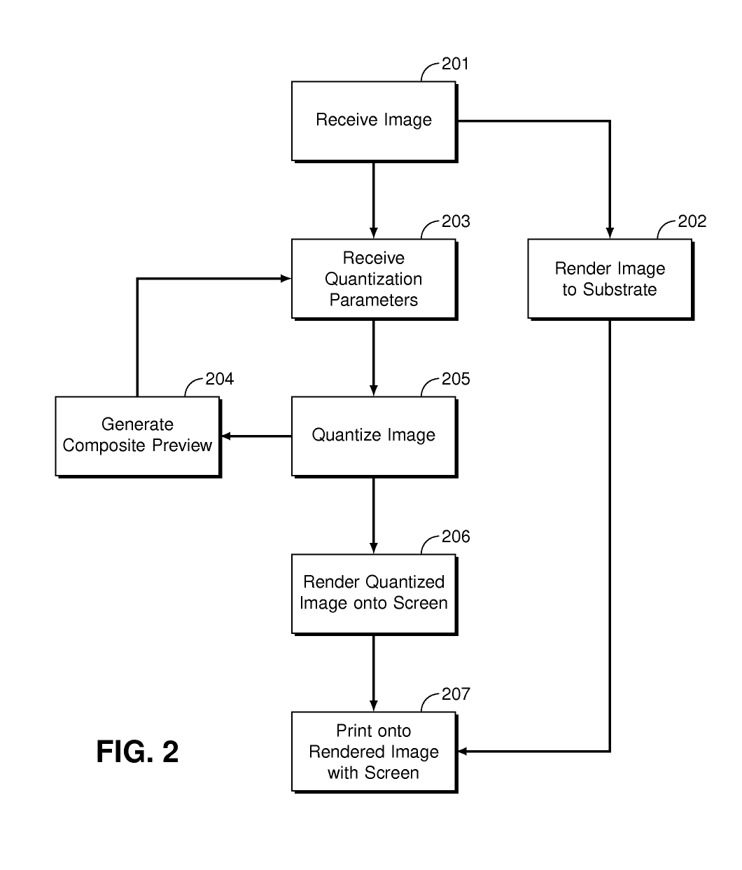

Referring now to FIG. 2, there is shown a flowchart of a process of generating a printed image in accordance with one particular embodiment of the present invention. The process of FIG. 2 may be performed in part or in whole by computer system 101 of FIG. 1, for example. If desired, additional embodiments may be provided in which more or fewer steps are performed, and/or steps may be connected or arranged differently from what is shown, without departing from the scope of the present invention.

In step 201, data of an original image is received for processing. For purposes of definition, the received image data relating to a single image is referred to herein as the “received image”, the “received image data”, and/or the “original image data”. Additionally, for purposes of the present embodiment, when it is indicated that the received image data represents the original image, it is meant that the received imaged data represents the data for reproducing, reconstructing and/or representing the original image in its entirety. The received image data may be stored permanently or temporarily in image repository 102 of FIG. 1. Additionally, in accordance with one particular embodiment of the present invention, the received image data may be placed into an image repository 102 at the direction of a local user operating the computer system 101 and/or by an external user connected via a network connection, among other possibilities.

The received image data may represent a grayscale or color original image, and may be provided in various image formats and/or resolutions. In one particular embodiment, a non-lossy image format (e.g. Portable Network Graphics format) is used. In another particular embodiment of the invention, a lossy image format configured for high image fidelity (e.g. high-quality JPEG) is used to advantageously provide a higher quality digital print. In one embodiment, the image resolution is at least a certain magnitude, to improve the quality of the resulting product. In such an embodiment, the minimum resolution for the original image may be 300 pixels per inch. If an image is found to not satisfy some or all of the described requirements, the system may continue processing without warning, provide the user with warnings and/or an opportunity to provide acceptable data, and/or automatically modify the provided image, for example by interpolating pixels or reducing the indicated dimensional size of the image, as desired.

In step 202, the received image data is used to print or render the original image onto a physical substrate using a non-silk screen technique and without quantization (other than minimal generalized brightness/contrast/color adjustments and/or resizing). For purposes of definition herein, an original image rendered or printed on a physical article or non-digital medium is referred to herein as the “first printed image” or “original printed image”. For example, in one preferred embodiment of the invention, a first printed image is produced by photographic development processes, i.e., digital printing or traditional photographic chemical development, but not by silk screening or silk printing onto the substrate. This rendering may be performed, for example, by the image printing system 104 of FIG. 1. The first printed image (i.e., original printed image) is a representation of the original image printed or rendered on a physical article and visible by non-electronic means, without regard to whether or not it has been resized. For example, an optical or digital photograph reproduced on a substrate (even if enlarged or reduced) is referred to herein as an original printed image. However, this is not meant to be limiting, as other received image data (i.e., digital rendering, drawing, etc.) can be printed or rendered to a substrate and still be an original printed image, as used herein.

Additionally, for purposes of the present embodiment, the received image data may be rendered on or printed to different physical media, such as paper, apparel, textiles, stretched canvas, and the like. In some embodiments, the physical medium and/or printing system are chosen to produce a high quality print. For example, archival photo paper may advantageously provide a sharper print from digital data, thus producing a clearer resulting product. In an alternate embodiment, the image may originate on a physical medium or substrate (such as from a film based process) which is scanned by a user in order to produce the received image data. In such an embodiment, it may not be necessary to perform the rendering of step 202, if desired, as an original printed image already exists.

In step 203, the system receives image quantization parameters, and at step 205 the system quantizes the image received at step 201 based on those quantization parameters. Digital image data generally represents an image using thousands or millions of colors, and the process of image quantization involves converting an image that has numerous colors to an image with smaller number of colors. In an embodiment, the result of the image quantization at step 205 is a quantized image of two colors, for example black and white, though other quantized images may be produced in various embodiments. The quantization may be performed, for example, by image processing module 103 of FIG. 1.

Although the simplest method of image quantization is simply replacing every pixel of an image with the closest pixel available to the quantized image, there are numerous algorithms for quantization that produce different results. Algorithms such as dithering, median cut, octree clustering, and the like, may be applied.

In one particular embodiment, the following procedure is employed.

First, a color image is converted to an 8-bit grayscale image. Methods for performing this conversion are known to those of skill in the art, for example using a weighted average of color components based on a luminosity function.

Second, the grayscale image may then be converted to a two-color image of black and white pixels, using an image filter. In an embodiment, the image filter is the “Stamp” filter in Adobe Photoshop. The filter may be adjustable for brightness, so that more or fewer of the grayscale pixels are converted to white. The filter may further be adjustable for smoothness, which may be implemented for example by applying a blurring function to the image before or after reducing the image to black and white. The smoothness filter may advantageously reduce the degree of artifacts in the black and white image that result from minute details in the image.

In the aforementioned embodiment, the adjustable parameters may include the luminance function for grayscale conversion, the brightness level for the image filter, the smoothness level for the image filter, and so on. In alternate embodiments, any subset of these parameters and/or other parameters may be received at step 203. The parameters to be received may depend on the particular quantization algorithm being applied at step 205. Like the image received at step 201, the parameters may be received locally at the computer system and/or from an external user via a network connection and/or other mechanism.

Optionally in one particular embodiment, a composite preview is generated at step 204. The composite preview may enable the user to see the results of the quantization process at step 205, so that the user may reenter and/or adjust quantization parameters at step 203, if desired. This embodiment, thus, advantageously enables the user to analyze the quantization results and improve upon them, as desired. The composite preview may include the quantized image (an image generated from the quantized image data) alone, and/or the quantized image overlaid upon the original image (generated from the non-quantized received image data), to provide a preview of the resulting generated print. In some embodiments, to make the overlay apparent to the user, the overlay may be configured to be enabled or disabled by the user (e.g., through layers in the ADOBE® PHOTOSHOP® software), and/or the overlay may be rendered as semi-transparent, blinking, fading in or out, or the like.

The composite preview can display the quantized image rendered in one or more colors, to further approximate the anticipated result. For example, the black pixels of the quantized image may be replaced with red pixels and overlaid on the original image, or the black pixels may be replaced with a gradient of various colors to simulate screen printing with multiple inks. In such an embodiment, the colors may be selected by the user and/or automatically selected, for example based on an analysis of the colors of the original image (e.g., colors complementary to the dominant colors of the original image may be selected).

At step 206, the quantized image is rendered onto a screen for printing. The screen may then be used at step 207 for printing upon the rendered image produced at step 202 and/or other images.

In one particular embodiment, the process of rendering the quantized image to a screen at step 206 generally includes preparing a screen by coating the screen with a photo emulsion compound, printing the quantized image to transparency sheets, placing those transparency sheets on the coated screen, exposing the combination of transparencies and screen to light, washing the unexposed portions of the coating off of the screen, and allowing the screen to dry. In one particular embodiment of the invention, the foregoing steps for preparing a screen are performed automatically under control of the computer system 101. In another embodiment of the invention, at least some of the screen preparation steps are performed manually, while others are performed automatically under control of the computer system 101. Other methods of preparing a screen for printing are known to those of skill in the art. The photo emulsion is generally a compound that hardens when exposed to light, so the areas of the screen where light is blocked due to printing on the transparency will remain unhardened and thus wash off, while the areas of the screen under transparent sections of the transparency will harden and thus not wash off. The time for exposure will depend on the nature of the emulsion compound and the strength of the exposure light; in an embodiment an exposure period of 50-90 seconds is used. The drying process may be sped up using a fan or other device. In some situations, the quantized image may be too large to fit on a single screen. In such a case, in an embodiment, multiple screens may be produced, each including a portion of the quantized image, and the multiple screens may be separately or jointly printed at step 207.

In one particular embodiment, when printing from the screen at step 207, the screen bearing the quantized image is placed in alignment with the rendered (i.e., original printed) image, meaning that the quantized image is printed at the same physical size as the rendered image and the screen is aligned, or registered, on top of the rendered image. Registration marks may be printed on the rendered image and/or quantized image to aid in registration. In an alternate embodiment, the quantized image may be resized, rotated, skewed, translated, or otherwise geometrically transformed to create different visual effects. For example, slightly reducing the quantized image in size and shifting it diagonally with respect to the rendered image when printing may produce a shadow-like effect.

The process of printing from a screen onto a physical medium at step 207 generally includes registering the screen on top of the physical medium, placing an ink or pigment, such as acrylic ink, onto the screen, and pushing the ink across the screen using a tool such as a squeegee. Other methods of printing from a screen are known to those of skill in the art. In one embodiment, multiple ink colors are used to produce gradient and blending visual effects. In an embodiment that employed the composite preview of step 204, the inks selected for printing at step 207 may correspond in color to the colors of the preview.

The printing at step 207 may be performed automatically, for example by screen printing system 105 of FIG. 1, possibly at the direction of computer system 101. The printing may additionally or alternatively include manual intervention steps, for example in the selection of the ink, alignment of the screen, and/or printing of the ink onto the physical medium with the rendered image. In alternate embodiments, other methods of printing, such as offset lithography, platen press printing, cylinder letterpress printing, hot foil stamping, and the like, may be used to provide further variety in visual effect, ease of automation, and/or other advantages; any combination of these and/or other printing techniques may be used as well. Furthermore, in various embodiments, multiple screens may be used to print atop a single image. For example, different quantization algorithms may be used to produce several screens, which may then be overlaid in different colors atop the rendered image.

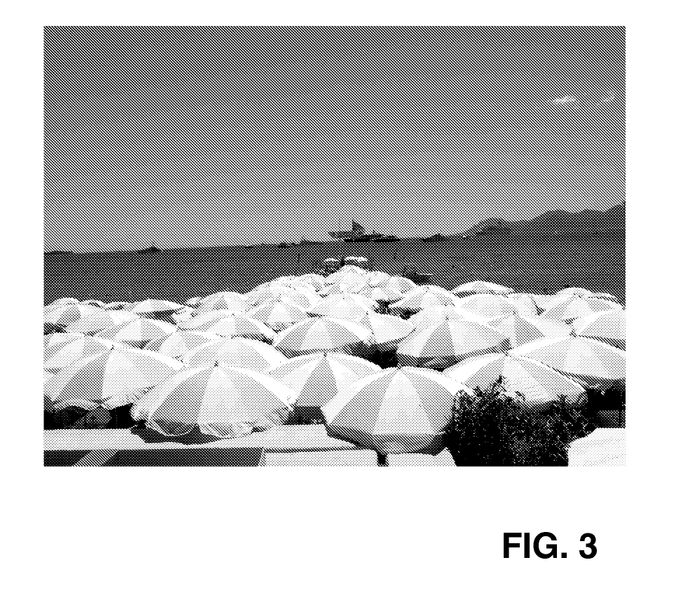

Referring now to FIG. 3, there is shown an exemplary image that is useful in illustrating a method in accordance with one particular embodiment of the present invention. The image of FIG. 3 contains substantial detail and a large number of colors, including gradients of colors in the sky. Such details generally are difficult to print using a screen printing technique, but can be printed using a number of digital and non-digital printing technologies, which may be employed for example by printing system 104 of FIG. 1 and at block 202 of FIG. 2. Data of the original image shown in FIG. 3 is stored in the image repository 102 of FIG. 1, while the image printing system 104 of FIG. 1 can produce an original printed image on a substrate from the original image data.

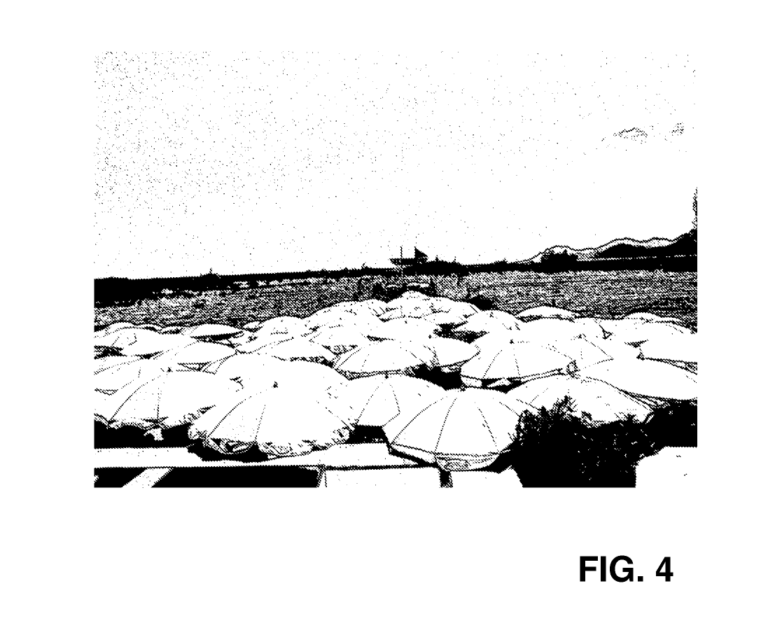

FIG. 4 is an example quantized image, generated according to methods described herein, based on the image of FIG. 3. As can be seen, the image is made up of black and white pixels, as a result of the quantization algorithm of step 205 for example. This image may then be rendered to a screen and printed, at steps 206 and 207.

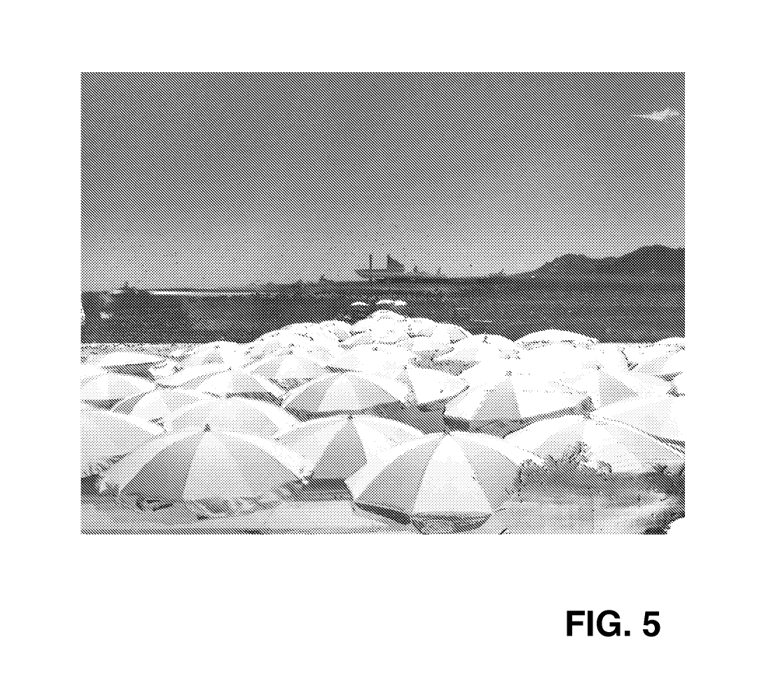

FIG. 5 is a combined print article prepared in accordance with the present invention. More particularly, in FIG. 5 shows the final product of the invention wherein colored inks have been applied to (i.e., overlaid on) the rendered original printed image of FIG. 3 using silk screens generated from the quantized image data, in accordance with FIG. 4. Note that the exemplary image of FIG. 5 provided in the present application is merely a digital representation and, as a consequence, does not display aspects of the screen printing technique that may be apparent in the actual print, such as reflectivity or texture of the ink. The screen printing, as described previously, may be used to print multiple colors onto the substrate rendered image, as shown in the example of FIG. 5.

Thus, as can be seen, the present invention produces a combined media article, wherein received image data representing an original image is used to generate silk screens representing a quantized image derived from the received image data. The resulting silk screens are used to silk screen colored inks onto a substrate that already has the original image printed or otherwise rendered thereon, using a non-screen printing (i.e., non-silk screening) technique, such as digital or ink jet printing.

Example Computer System

FIG. 6 illustrates a computer system 600 that can be used with any of the embodiments of the present invention. In general, embodiments of the aforementioned systems and methods may be implemented in various computer systems, such as a personal computer, a server, a workstation, an embedded system, or a combination thereof, for example, computer system 600. Certain embodiments of the combined media printing system of the present invention may be embedded as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. However, for purposes of explanation, system 600 is shown as a general purpose computer that is well known to those skilled in the art. Examples of the components that may be included in system 600 will now be described.

As shown, system 600 may include at least one processor 602, a keyboard 617, a pointing device 618 (e.g., a mouse, a touchpad, and the like), a display 616, main memory 610, an input/output controller 615, and a storage device 614. Storage device 614 can comprise, for example, RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. A copy of the computer program embodiment of the system can be stored on, for example, storage device 614. System 600 may also be provided with additional input/output devices, such as a printer (not shown). The various components of system 600 communicate through a system bus 612 or similar architecture. In addition, system 600 may include an operating system (OS) 620 that resides in memory 610 during operation. One skilled in the art will recognize that system 600 may include multiple processors 602. For example, system 600 may include multiple copies of the same processor. Alternatively, system 600 may include a heterogeneous mix of various types of processors. For example, system 600 may use one processor as a primary processor and other processors as co-processors. For another example, system 600 may include one or more multi-core processors and one or more single core processors. Thus, system 600 may include any number of execution cores across a set of processors (e.g., processor 602). As to keyboard 617, pointing device 618, and display 616, these components may be implemented using components that are well known to those skilled in the art. One skilled in the art will also recognize that other components and peripherals may be included in system 600.

Main memory 610 serves as a primary storage area of system 600 and holds data that is actively used by applications, running on processor 602. One skilled in the art will recognize that applications are software programs that each contains a set of computer instructions for instructing system 600 to perform a set of specific tasks during runtime, and that the term “applications” may be used interchangeably with application software, application programs, and/or programs in accordance with embodiments of the present teachings. Memory 610 may be implemented as a random access memory or other forms of memory as described below, which are well known to those skilled in the art.

OS 620 is an integrated collection of routines and instructions that are responsible for the direct control and management of hardware in system 600 and system operations. Additionally, OS 620 provides a foundation upon which to run application software. For example, OS 620 may perform services, such as resource allocation, scheduling, input/output control, and memory management. OS 620 may be predominantly software, but may also contain partial or complete hardware implementations and firmware. Well known examples of operating systems that are consistent with the principles of the present teachings include MICROSOFT WINDOWS (e.g., WINDOWS CE, WINDOWS NT, WINDOWS 2000, WINDOWS XP, and WINDOWS VISTA), MAC OS, LINUX, UNIX, ORACLE SOLARIS, OPEN VMS, and IBM AIX.

The foregoing description is illustrative, and variations in configuration and implementation may occur to persons skilled in the art. For instance, the various illustrative logics, logical blocks, modules, and circuits described in connection with the embodiments disclosed herein may be implemented or performed with a general purpose processor (e.g., processor 602), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

If implemented in software, the functions may be stored on or transmitted over a computer-readable medium as one or more instructions or code. Computer-readable media includes both tangible computer storage media and communication media including any medium that facilitates transfer of a computer program from one place to another. A storage media may be any available tangible media that can be accessed by a computer. By way of example, and not limitation, such tangible computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Resources described as singular or integrated can in one embodiment be plural or distributed, and resources described as multiple or distributed can in embodiments be combined. The scope of the present teachings is accordingly intended to be limited only by the following claims.

While a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

I claim:

1. A method of generating a print of an image, the method comprising:
receiving image data of an original image at a computer system including at least a non-transitory storage medium and a hardware processor communicatively connected thereto;
applying a quantization algorithm to the received image data to produce quantized image data, the quantization algorithm being executed on the hardware processor of the computer system;
creating a printing screen incorporating the quantized image data; and
printing one or more inks onto a physical substrate through the printing screen, the physical substrate having the original image printed or rendered thereon.

2. The method of claim 1, wherein the original image is printed or rendered on the physical substrate by a non-screen printing method.

3. The method of claim 1, wherein the quantization algorithm is based at least in part on one or more parameters configured to adjust the produced quantized image data.

4. The method of claim 1, wherein the quantization algorithm includes at least a first conversion of the received image data to a grayscale image, and further includes a second conversion of the grayscale image to produce the quantized image data.

5. The method of claim 3, wherein the second conversion is based at least in part on a brightness parameter and a blurring parameter.

6. The method of claim 1, further comprising displaying a preview of the quantized image to the user subsequent to applying the quantization algorithm.

7. The method of claim 5, further comprising receiving updated quantization parameters from the user, and reapplying the quantization algorithm based at least in part on the updated quantization parameters to update the quantized image data.

8. The method of claim 1, wherein the quantized image data represents an image in exactly two colors.

9. The method of claim 8, wherein the two colors are black and white.

10. The method of claim 1, wherein creating the printing screen comprises creating a plurality of printing screens, each of which incorporates a portion of the quantized image data.

11. The method of claim 1, wherein printing onto the physical substrate comprises registering the printing screen in alignment with the rendering of the image data on the physical substrate.

12. The method of claim 1, wherein the physical substrate is a sheet of archival photo paper.

13. The method of claim 1, wherein the printing screen is created automatically under control of the computer system.

14. The method of claim 1, wherein the printing screen is created at least in part by a manual process separate from the computer system.

15. The method of claim 1, wherein the one or more inks are printed onto the physical substrate automatically under control of the computer system.

16. The method of claim 1, wherein the one or more inks are printed onto the physical substrate at least in part by a manual process separate from the computer system.

17. A computer system, comprising:
a computer processor;
a storage medium communicatively connected to the computer processor, the storage medium having stored thereon a plurality of modules configured to be executed on the computer processor, the plurality of modules including:
an image receiving module configured to receive image data representing an original image;
a quantization module including a quantization algorithm; and
the computer processor configured to process the received image data representing an original image with the quantization algorithm to generate quantized image data used to generate a printing screen incorporating the quantized image data, said printing screen configured to overlay one or more inks onto a physical substrate through the printing screen in alignment with the original image printed or rendered on the physical substrate by a non-screen printing technique.

18. A combined media printing system, comprising the computer system of claim 17.

19. The combined media printing system of claim 18, further comprising:
a screen printing system configured to print one or more inks onto a physical substrate through the printing screen in alignment with the original image printed or rendered on the physical substrate; and
an image printing system configured to print or render the original image on the physical substrate by a non-screen printing technique.

20. A non-transitory computer-readable medium having stored thereon a plurality of instructions executable by a processor of a computer system, to configure the computer system to:
receive image data representing an original image; and
apply a quantization algorithm to the received image data to produce quantized image data, the quantized image data being configured to be used in creating a printing screen representing the quantized image data and configured to print one or more inks onto a physical substrate through the printing screen in alignment with the original image printed or rendered thereon.
